(19) United States
(12) Patent Application Publication
(10) Pub. No.: US 2007/0070528 A1
(43) Pub. Date: Mar. 29, 2007

(54) Optical inspection device

(75) Inventors: Ming-Chich Chung, Xinzhuang City (TW); Ken Yen, Xinzhuang City (TW); Chien-Fu Chen, Xinzhuang City (TW); Walong Sheu, Xinzhuang City (TW); Yan-Gu Lai, Xinzhuang City (TW); Ace Lin, Xinzhuang City (TW); Chiung-Hui Chen, Xinzhuang City (TW); Hsien-Chung Chiu, Xinzhuang City (TW)

Correspondence Address: LEONG C LEI, PMB # 1008, 1867 YGNACIO VALLEY ROAD, WALNUT CREEK, CA, 94598, US

(73) Assignee: MICRO-DIGITAL AUTOMATION CORP.

(21) Appl. No.: 11/324,305

(22) Filed: Jan. 4, 2006

(30) Foreign Application Priority Data
Sep. 28, 2005 (TW) 094216670

(51) Int. Cl. G02B 7/02

(52) U.S. Cl. 359/819

(57) ABSTRACT

An optical inspection device is provided herein to achieve the accuracy and convenience of inspecting optical glasses and planar optical objects. The optical inspection device mainly has the optical inspection lenses installed on the arms of a U-shape member that surrounds the object to be examined. Then, by moving the U-shaped member along orthogonal directions, the entire surface of the object could be examined accurately.

### BACKGROUND OF THE INVENTION

(a) Technical Field of the Invention

The present invention generally relates to optical inspection devices, and more particularly to an optical inspection device utilizing a U-shape moving member with inspection lenses to examine still objects.

(b) Description of the Prior Art

In the display industry, prior-inspection of optical glasses such as the glass substrates of TFT-LCDs for their RGB values, flatness, etc. is the key to the quality of the final product. The device used for the optical inspection could be broadly categorized into two major groups: devices that move the inspected object relative to still optical inspection lenses, and devices that move the optical inspection lenses,relative to still objects.

For the former, the size of the inspected object and the speed and stability of the device's moving of the inspected object all would affect the accuracy of the examination. Usually, these devices also take up a lot of space and are inconvenient in transportation and installation. As such, fewer devices adopt this approach.

For the latter, these devices do not have the foregoing disadvantages. However, as the optical inspection lenses have to be installed at separate and opposing moving members, their focus and calibration would be difficult and therefore take a lot of time and effort.

### SUMMARY OF THE INVENTION

The primary purpose of the present invention is to provide an inspection to achieve the accuracy and convenience of inspecting optical glasses and planar optical objects.

The present invention mainly has the optical inspection lenses installed on the arms of a U-shape member that surrounds the object to be examined. Then, by moving the U-shaped member along orthogonal directions, the entire surface of the object could be examined accurately.

As the optical inspection lenses are installed on the U-shape member, which are at a constant distance to the inspected object, it is easier to adjust or replace the lenses. In addition, once the lenses are focused or calibrated, they are seldom required to be calibrated or focused again. Furthermore, as the inspected object is left still, the accuracy and reliability of the inspection is also much improved.

The foregoing object and summary provide only a brief introduction to the present invention. To fully appreciate these and other objects of the present invention as well as the invention itself, all of which will become apparent to those skilled in the air, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an embodiment the optical inspection device of the present invention.

FIG. 2 is a side view of the optical inspection device of FIG. 1.

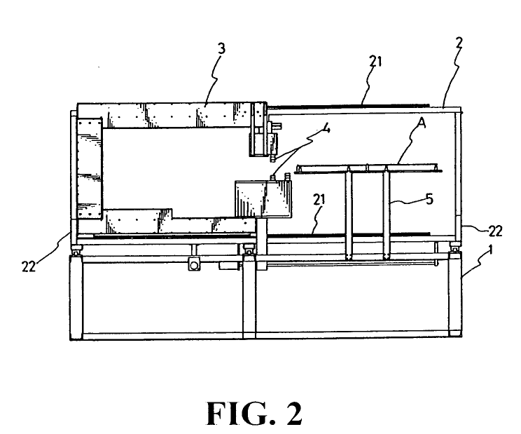

FIG. 3 is a top view of the optical inspection device of FIG. 1.

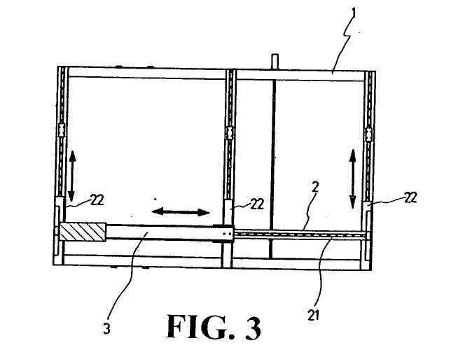

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention.

Various changes to the described embodiments may be made in the function and arrangement of the elements described without departing from the scope of the invention as set forth in the appended claims.

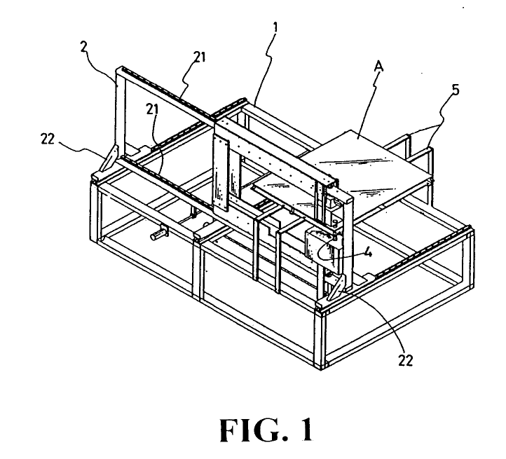

As shown in FIGS. 1˜3, the device according to the present invention mainly contains a platform 1, a frame 2, a U-shaped sliding member3, a pair of optical inspection lenses 4, and a U-shaped supporting member 5.

A number of tracks (not numbered) are configured on the top surface of the platform 1, which are in parallel along a first direction. The U-shaped supporting member 5 is fixedly installed at an appropriate location on the top surface of the platform 1 along the first direction with its opening facing toward the platform 1.

On each of the tracks, there is a seat 22 that can slide along the track. The frame 2 encircles the supporting member 5 and is fixedly erected on the seats 22 so that the frame 2 could slide along the tracks back and forth along the first direction. The frame 2 has tracks 21 configured on its upper and lower sides.

The U-shaped sliding member 3 is configured inside the frame 2 so that its opening is facing toward the supporting member 5 and that it can slide along the tracks 21 in a second direction orthogonal to the first direction. The optical inspection lenses 4 are installed at appropriate locations on the upper and lower arms of the sliding member 3 respectively.

The object (not numbered) to be inspected is placed flatly on top of the supporting member 5. The optical inspecting lenses 4 are focused on the object and, by moving the frame 2 along the first direction and moving the sliding member 3 along the second direction, every point on either side of the object's surface area A could be examined.

In alternative embodiments, additional pairs of optical inspection lenses 4 could be configured along the upper and lower arms of the sliding member 3, each of which is for the testing of a specific optical characteristic of the object such as the RGB values, flatness, etc.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An optical inspection device comprising:
a platform having a plurality of parallel tracks configured on the top surface of said platform along a first direction;
a U-shape supporting member fixedly installed at an appropriate location on the top surface of said platform along said first direction with its opening facing toward said platform, and with the object to be inspected being placed flatly on said supporting member;
a frame erected on the top surface of said platform encircling said supporting member and the object to be inspected and capable of sliding along said tracks along said first direction, said frame has a plurality of tracks configured on its upper and lower sides;
a U-shaped sliding member configured inside said frame with its opening facing toward said supporting member and the object to be tested, said sliding member capable of sliding along said tracks of said frame in a second direction orthogonal to said first direction; and
a pair of optical inspection lenses installed at appropriate locations on the upper and lower arms of said sliding member respectively.

2. The optical inspection device according to claim 1, further comprising at least an additional pair of optical inspection lenses installed at appropriate locations on the upper and lower arms of said sliding member.
